(19) United States
(12) Patent Application Publication
(10) Pub. No.: US 2021/0139373 A1
(43) Pub. Date: May 13, 2021

(54) PASTE FOR USE IN MINING PROCESSES

(71) Applicant: Yen-Jui Ting, Mississauga (CA)

(72) Inventor: Yen-Jui Ting, Mississauga (CA)

(21) Appl. No.: 16/486,650

(22) PCT Filed: Feb. 16, 2018
(86) PCT No.: PCT/CA2018/050177

§ 371 Date: Aug. 16, 2019

(30) Foreign Application Priority Data
Feb. 17, 2017 (CA) 2958381

(51) Int. Cl. C04B 18/12; C04B 28/04; C04B 16/06; E21F 15/00

(52) U.S. Cl. CPC C04B 18/12; C04B 28/04; C04B 2103/0088; E21F 15/005; C04B 16/06

(57) ABSTRACT

Disclosed is a paste for use in mining processes, such as backfilling and cemented rock fill, to provide improved early and late-stage strength at a lower overall cost. The paste includes mine tailings, one or binding agents, engineering backfill and water. The engineering backfill fibers are typically plastic fibers obtained from plastic products, partially plastic products, recycled plastic products, or partially recycled plastic products. Also disclosed are methods of backfilling a portion of a mine and uses of the paste in mining processes.

### FIELD OF THE INVENTION

The present invention is related to the mining industry. More specifically, the present invention is related to paste for use in mining processes.

### BACKGROUND OF THE INVENTION

A properly designed paste backfill allows appropriate tailings disposal and stabilizes the underground. A paste is made of tailings, binder and mix water and is often backfilled in a pipeline or by trucks. When mining in close proximity to the fill is required, relatively high binder content is used to produce high early strength and high long term strength. On the other hand, low binder content may be used in applications where the strength requirement is low. Often, the decision to reduce the binder content is driven by cost. However, depending on the geometry of the stopes, backfill schedule, and the properties of the tailings, this “low” or minimum binder content may vary. When the paste is not meeting the minimum specification, there is a risk of inadequate ground support or liquefaction.

Besides binder dosage, using different types of cement produces different rates of strength gain in the paste backfill. For example, high early strength cement can be used when rapid strength gain is required. While using slag in the mix cement tends to have a slower strength development, however, it produces higher long term strength than of ordinary Portland cement.

A well-designed paste backfill should meet the strength requirement within a given time, such that the time it takes for the paste to gain strength does not become the bottleneck of the mining process. At the same time, the cost per tonne of backfill should be kept low. Paste backfill, like concrete, is strong in compression and weak in tension. Delaying crack formation and propagation is one of the strategies to improve the strength of paste backfill. Moreover, saving cement binder is important as it may not only save cost, but also significantly reduces the carbon footprint for mining backfill.

### SUMMARY OF THE INVENTION

According to an aspect of the present invention, there is provided a paste for use in mining processes. The paste containing: mine tailings; one or more binding agents; engineering backfill fiber; and water.

In one embodiment, the engineering backfill fiber is a plastic fiber, such as, but not limited to, a plastic fiber from polyester; polyethylene terephthalate; polyethylene; high-density polyethylene; polyvinyl chloride; low-density polyethylene; polypropylene; polystyrene; high impact polystyrene; polyamides; acrylonitrile butadiene styrene; polyethylene/acrylonitrile butadiene styrene; polycarbonate; polycarbonate/acrylonitrile butadiene styrene; or polyurethanes. The plastic fiber can be obtained from a plastic product, partially plastic product, recycled plastic product or partially recycled plastic product.

In another embodiment, the one or more binding agents are cement, such as Portland cement, and supplementary cementing materials, such as ground granulated blast furnace slag, fly ash, natural pozzolans, cement kiln dust, and waste glass. In some preferred embodiments, the Portland cement is ASTM C150 Type 1 or CSA A3001-03 Type GU, and the supplementary cementing material is ground granulated blast furnace slag.

In other embodiments, the one or more binding agents are a composition comprising slag and Portland cement. The composition being 90 parts slag and 10 parts Portland cement, in some preferred embodiments.

In further embodiments, the composition of binding agents is provided at 3% by weight of the tailings, and the engineered backfill fiber is provided at 0.3% by weight of the tailings.

In another embodiment, the paste is used as backfill paste or in cemented rock fill.

According to another aspect of the present invention, there is provided a method of backfilling a portion of a mine. The method involving: providing the paste backfill as described above; and pumping the paste backfill into a portion of a mine.

According to a further aspect of the present invention, there is provided use of the paste backfill described above for backfilling a portion of a mine.

### BRIEF DESCRIPTION OF THE DRAWINGS

These and other features, aspects and advantages of the present invention will become better understood with regard to the following description and accompanying drawings wherein:

FIG. 1 is a graphical representation of the strength of samples with and without engineering backfill fiber after selected periods of curing time.

### DESCRIPTION OF THE INVENTION

The following description is of one particular embodiment by way of example only and without limitation to the combination necessary for carrying the invention into effect.

The paste disclosed herein can be used for a variety of mining processes, including, but not limited to, as backfill paste, in cemented rock fill or hydraulic fill.

The paste includes a base composition of components that are typically found in paste backfill, including mine tailings, binding agents and water. In addition, the paste includes engineered backfill fiber to reduce the overall cost of production of the paste and to improve the early and long-term strength of paste.

The base paste includes mining tailings, binding agents (binders) and water. Those skilled in the art will appreciate the various types of mining tailings and binders, and the relevant concentrations of each component, that are typically used in the production of paste backfill. For example, mine tailings typically represent between 70% and 80% of the weight of the paste mix. In some embodiments, the mine tailings represent approximately 74% of the weight of the paste mix.

The actual choice of the mine tailings to be used in the paste depend upon the binder being used. For example, capability between the physical, chemical and mineralogical properties of the mine tailings and the binding agents should be considered. In one embodiment, the mine tailings are from a tailings pond and dry stacked. These tailings are screened to remove clay, with an average of 25-35% passing a 20 micron screen and being used for the paste.

The paste contains one or more binding agents or binders. The binding agents typically, but not always, include cement and supplementary cementing materials. Commonly used cement includes one of ASTM C150 Type 1 and CSA A3001-03 Type GU Portland cement. The cement is provided along with the supplementary cementing material to form a composition. The actual ratio of cement to supplementary cementing materials can vary, however, it is common that more cement is used compared to the supplementary cementing materials. For example, a composition having 90 parts cement to 10 parts supplementary cementing material will be suitable for the purposes of the present paste.

Supplementary cementing materials can include, but are not limited to, ground granulated blast furnace slag, fly ash, natural pozzolans, cement kiln dust, waste glass or combinations of any of these. In one embodiment, the supplementary cementing material is ground granulated blast furnace slag.

The paste disclosed herein also includes an engineered backfill fiber. In most cases, the engineered backfill fiber is a plastic fiber that is obtained from a plastic product, partially plastic product, recycled plastic product, partially recycled plastic product or a combination of two or more of these. Preferred engineered backfill fibers come from domestic waste products, such as water bottles, soft drink bottles and food packaging, or industrial waste products, such as film, purge/lumps, or packaging that does not meet spec. The engineered plastic fibers can be produced from the products by sorting the different types of plastic, cleaning the plastic, shredding the plastic and then melting it to form fibers. Depending on the application, the length and diameter of the fibers can be altered to provide different properties to the paste that it is eventually used in.

The plastic fibers can be one or a combination of multiple polyester, polyethylene terephthalate, polyethylene, high-density polyethylene, polyvinyl chloride, low-density polyethylene, polypropylene, polystyrene, high impact polystyrene, polyamides, acrylonitrile butadiene styrene, polyethylene/acrylonitrile butadiene styrene, polycarbonate, polycarbonate/acrylonitrile butadiene styrene, or polyurethane fibers.

In some embodiments, the engineering backfill fibers are provided at approximately 0.3% by weight of the tailings. However, it is contemplated that the actual amount of engineering backfill fibers used in the paste will depend on the type of mine tailings and binding agents used in the paste, as well as the type(s) of fibers used in the engineering backfill fiber.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

### Example

To understand the effect of EBF on the paste backfill, three types of paste were produced, as shown in Table 1 below.

TABLE 1

| | Binder* | EBF* |
|---|---|---|
| Paste | 3% | 0% |
| Paste + EBF-A | 3% | 0.3% |
| Paste + EBF-B | 3% | 0.3% |

*as percentage of tailings

The base paste contained tailings and binder (3% by weight of tailings), with approximately 74 weight percent (wt %) solid. Slag with Portland cement (90/10), 3% by weight of the tailings, was used as the binder. Three buckets of paste were collected from the backfill plant. A slump test was performed on the paste with no EBF, the base paste, and measured 9″ slump. Cylinders (3″×6″) were casted with the base paste. EBF-A and EBF-B, 0.3% by weight, of the tailings was added separately and thoroughly mixed into the other two buckets of paste. To test the effect of fiber length on the overall properties of the paste, the engineered backfill fibers, EBF-A and EBF-B, were produced as plastic fibers of different length. Cylinders were then casted with EBF-A and paste with EBF-B. After 24 hour, bleed water was removed from the cylinders, and the samples were stored in heat sealed bags.

After EBF was added to the paste and was thoroughly mixed in, the paste appeared to reduce its flowability. Some fibers were visible in the paste during mixing but the fiber did not seem to segregate from the paste. The paste with EBF retained the shape better and appeared less flowable.

After 24-hour curing, paste without EBF produced on average 4% bleed water, using the definition outlined in ASTM standard C232. On the other hand, samples with EBF produced no measurable bleed water. It appeared the water was retained in the paste.

Unconfined Compressive Strength (UCS) testing was performed on the samples after 7, 21, 56, and 285 days. A set of three cylinders were tested for each test. The results were recorded and the average of each set was calculated. As expected, samples with no EBF had pieces break away and detach from the cylinder. On the other hand, samples reinforced with EBF fractured without little fragments detaching from the sample after the UCS test.

The average UCS results of the base paste samples, samples reinforced with EBF-A, and EBF-B are summarized in Table 2 and plotted in FIG. 1. Paste reinforced with EBF developed significantly higher 7-day UCS than of the paste with no EBF (Base). Respectively, EBF-A and EBF-B improved the 7-day UCS by a factor of 4.5 and 2.5. This improvement in early strength is particularly useful in backfill in preventing liquefaction and delays in backfill.

TABLE 2

| | Average UCS (kPa) | | |
|---|---|---|---|
| Days Cured | Base | EBF-A | EBF-B |
| 7 | 21.3 | 97.3 | 53.7 |
| 21 | 190.3 | 379.3 | 223.3 |
| 56 | 424.0 | 712.7 | 498.3 |
| 285 | 526.7 | 916.7 | 698.3 |

After 21 and 56 days, all samples gained more strength as cement hydration continued. EBF-A had the most dramatic increase while the difference between EBF-B and Base narrowed as illustrated in FIG. 1. With the same cement content, paste with EBF developed higher UCS. In operation, this improvement in UCS can reduce the binder consumption, as less binder would be required to achieve the strength specification. By decreasing the binder consumption, there is a cost savings but also the carbon footprint is reduced in the backfill.

After 285 days, paste with EBF continued to exhibit higher strength than that of base paste (with no EBF). This suggests that EBF was stable and did not degrade.

1. A paste for use in mining processes, the paste comprising:
mine tailings;
one or more binding agents;
engineering backfill fiber; and
water.

2. The paste of claim 1, wherein the engineering backfill fiber is a plastic fiber.

3. The paste of claim 2, wherein the plastic fiber is a fiber from the group consisting of: polyester; polyethylene terephthalate; polyethylene; high-density polyethylene; polyvinyl chloride; low-density polyethylene; polypropylene; polystyrene; high impact polystyrene; polyamides; acrylonitrle butadiene styrene; polyethylene/acrylonitrile butadiene styrene; polycarbonate; polycarbonate/acrylonitrle butadiene styrene; and polyurethanes.

4. The paste of claim 2, wherein the plastic fiber is obtained from a plastic product, partially plastic product, recycled plastic product or partially recycled plastic product.

5. The paste of claim 1, wherein the one or more binding agents are cement and supplementary cementing materials.

6. The paste of claim 5, wherein the cement is Portland cement.

7. The paste of claim 6, wherein the Portland cement is ASTM C150 Type 1 or CSA A3001-03 Type GU.

8. The paste of claim 5, wherein the supplementary cementing materials are selected from the group consisting of: ground granulated blast furnace slag; fly ash; natural pozzolans; cement kiln dust; and waste glass.

9. The paste of claim 8, wherein the supplementary cementing material is ground granulated blast furnace slag.

10. The paste of claim 1, wherein the one or more binding agents are a composition comprising slag and Portland cement.

11. The paste of claim 10, wherein the composition is 90 parts slag and 10 parts Portland cement.

12. The paste of claim 10, wherein the composition is provided at 3% by weight of the tailings.

13. The paste of claim 1, wherein the engineered backfill fiber is provided at 0.3% by weight of the tailings.

14. The paste of claim 1, wherein the paste is used as backfill paste or in cemented rock fill.

15. A method of backfilling a portion of a mine, comprising:
providing the paste backfill of claim 14; and
pumping the paste backfill into a portion of a mine.

16. (canceled)
